(19) United States
(12) Patent Application Publication
(10) Pub. No.: US 2015/0163715 A1
(43) Pub. Date: Jun. 11, 2015

(54) GRANULAR CONTROL FOR OFFLOADING COMMUNICATION SERVICES OVER MULTIPLE ACCESS NETWORK

(71) Applicants: AT&T Mobility II LLC, Atlanta, GA (US); AT&T Intellectual Property I, L.P., Atlanta, GA (US)

(72) Inventors: Jayanta Das, Morganville, NJ (US); Joseph Bailey, La Grange, IL (US); Vandana S. Chakravarti, Marlboro, NJ (US); Ann Nichols, Alpharetta, GA (US); Glenn Petry, Williston Park, NY (US); Karen Marie Stansbury, Canton, GA (US)

(73) Assignees: AT&T Mobility II LLC, Atlanta, GA (US); AT&T Intellectual Property I, L.P., Atlanta, GA (US)

(21) Appl. No.: 14/099,664

(22) Filed: Dec. 6, 2013

(51) Int. Cl. H04W 36/22

(52) U.S. Cl. CPC H04W 36/22

(57) ABSTRACT

A radio access network system is described that determines a wireless offloading schema associated with a user equipment or device. The user equipment device can receive input representing a user preference for offloading determined communication services to a determined network. Based on the offloading schema, a user equipment device can select a network to send and receive transmissions associated with a determined communication service.

### TECHNICAL FIELD

The disclosed subject matter relates to Internet Protocol Multimedia Core Network Subsystem based communication services, and, more specifically, to a wireless offloading system that offloads services between access networks.

### BACKGROUND

Impending technology transformations in next generation diverse access networks and feature rich application/service layer advances can adversely impact perceived user experience when end-points (e.g., handheld devices, subscriber units, user equipment units, and the like) and their associated access technology functionalities are diverse in capabilities.

### BRIEF DESCRIPTION OF DRAWINGS

FIG. 1 is an illustration of a system for managing wireless offloading of a transmission associated with a communication service, in accordance with aspects of the subject disclosure.

FIG. 2 is an illustration of a system for managing wireless offloading of a transmission associated with a communication service including a network detection component, in accordance with aspects of the subject disclosure.

FIG. 3 is an illustration of a system for managing wireless offloading of a transmission associated with a communication service including an interface component, in accordance with aspects of the subject disclosure.

FIG. 4 is an illustration of a system for managing wireless offloading of a transmission associated with a communication service including an interface component in a network environment, in accordance with aspects of the subject disclosure.

FIG. 5 is an illustration of a system for managing wireless offloading of a transmission associated with a communication service including offloading selection scheme, in accordance with aspects of the subject disclosure.

FIG. 6 is an illustration of a system for managing wireless offloading of a transmission associated with a communication service including a notification display, in accordance with aspects of the subject disclosure.

FIG. 7 illustrates a method for enhancing user experience for Internet Protocol Multimedia Core Network Subsystem based rich communication services in multiple access wireless communication networks/infrastructures, in accordance with aspects of the subject disclosure.

FIG. 8 illustrates a method for enhancing user experience for Internet Protocol Multimedia Core Network Subsystem based rich communication services in multiple access wireless communication networks/infrastructures including rendering wireless offloading options, in accordance with aspects of the subject disclosure.

FIG. 9 illustrates a further method for enhancing user experience for Internet Protocol Multimedia Core Network Subsystem based rich communication services in multiple access wireless communication networks/infrastructures including apply a schema based on a network, in accordance with aspects of the subject disclosure.

FIG. 10 is a block diagram of an example embodiment of a mobile network platform to implement and exploit various features or aspects of the subject disclosure.

FIG. 11 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Broadband access infrastructure—in mobility and wire-line—has been evolving and is now transitioning to next generation technologies such as, in mobility long term evolution (LTE), the adoption and implementation of LTE-Advanced technical standards, in wire-line the implementation of IEEE 802.11ac standards and utilization of gigabit passive optical networks (G-PON). Implementation of such next generation technologies has led to the implementation and the desire to utilize applications that are intensely feature rich that, until recently, have been unavailable, unknown, and/or untenable using existing circuit switched telecommunication infrastructures.

Various industry alliances and standards organizations such as Open Mobile Alliance (OMA), Global System for Mobile Communications Association—originally Groupe Special Mobile (GSM), the 3^{rd} Generation Partnership Project (3GPP), and others have been standardizing application and service layer features for internet protocol (IP) based voice, video, and messaging at an accelerated pace. The rich communication suite (RCS) framework specifications from the Open Mobile Alliance and the Global System Mobile Communications Association are examples the provide possibilities to offer feature rich multimedia services to consumers.

The practical concern for telecommunication carriers and/or service providers in regard to the foregoing can be the deterioration in perceived user experience (e.g., a user's perceived experience) associated with end-points (e.g., mobile terminals, handheld devices, user equipment units, smart phones, cell phones, access terminals, laptop computers, tablet computers, notebook computers, devices (e.g., portable or nonportable) with one or more processors, storage aspects, and/or memories, desktop computers, and the like) and/or their respective access networks. In another aspect, as applications demand more bandwidth, additional strain can be places on a network, such as increased load, decreased throughput and the like. Additionally, a cost can increase as bandwidth usage over particular networks increase. For instance, when an application consumes data—using technologies that allow electronic devices to exchange data or connect to the internet wirelessly using radio waves, such as a Wi-Fi access technology, that are typical where Home eNodeB stations and/or wireless access points are in common use (e.g., coffee shops, airport transit areas, . . . ) and long term evolution technology as implemented by a wireless telecommunication provider/carrier—a user can be charged a fee based on bandwidth utilization. To reduce the cost, a system can offload data to a cheaper or less expensive network. Thus it is important to have a mechanism for user control over such dynamic environment.

In accordance with an embodiment, the subject disclosure describes a system that can comprise a memory to store executable instructions, and a processor, coupled to the memory, that facilitates execution of the executable instructions to perform operations. The operations can include initiating a rendering, on a user equipment device, of a wireless offloading selection display, and receiving input, by the wireless offloading display, that represents a preference for offloading transmissions associated with a communication service. The operations can further include, determining an access network technology type to use for transmissions, and altering a connection from a first network device of a first communication network to a second network device of a second communication network. The access network technology type used by the user equipment to access the service network device can be determined as a function of a wireless offloading scheme, an access network parameter and access network availability.

In accordance with a further embodiment, the subject disclosure describes a method, comprising a series of acts that include rending of a wireless offloading selection display, receiving input for wireless offloading preferences, determining a wireless offloading schema, and applying a wireless offloading scheme to select a communication network for a transmission associated with a communication service.

In accordance with a still further embodiment, the subject disclosure describes a computer readable storage device comprising instructions that, in response to execution, cause a computing system comprising a processor to perform operations. The operation can include rending of a wireless offloading selection display, receiving input for wireless offloading preferences, determining a wireless offloading schema, and applying a wireless offloading scheme to select a communication network for a transmission associated with a communication service.

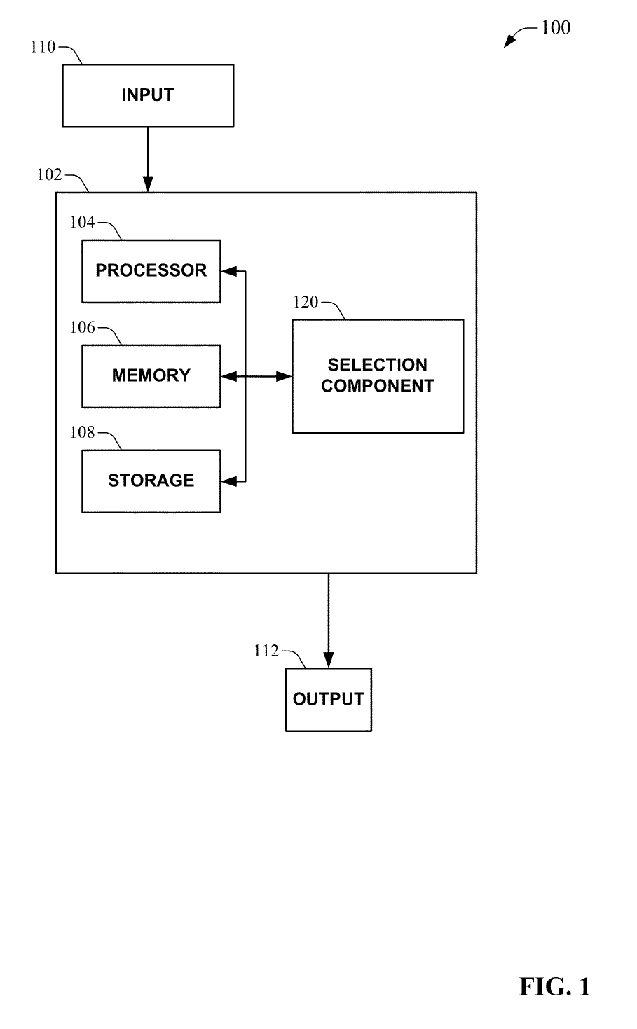

Turning now to the figures, wherein FIG. 1 illustrates a system 100 for managing network selections, where user equipment devices access, communicate, and/or conduct data interchange using disparate access network technology types. System 100 can be included in a user equipment device, such as a subscriber station, mobile device, access terminal, laptop computer, desktop computer, smart phone, cellular phone, notebook computer, tablet computer, personal digital assistant (PDA), and the like. System 100 can include offloading component 102 that comprises selection component 120 that can be coupled to processor 104, memory 106, and storage 108. As illustrated, selection component 110 can be in communication with processor 104 for facilitating operation of computer executable instructions, memory 106 for storing data and the computer executable instructions and components such as selection component 120 (which can facilitate selection of a network based on a preference), and storage 108 for providing longer-term storage of data and/or computer executable components and instructions. Additionally, system 100 can also receive input 110 for use, manipulation, and/or transformation by offloading component 102 to produce one or more useful, concrete, and tangible result. Further, system 100 can also generate and output the useful, concrete, and tangible result produced by selection component 120 as output 112.

Selection component 120 can receive, as input 110, signals from access points and input indicative of a user's selection. In response to receiving input 110, selection component 120 can determine a wireless offloading schema or connection preference based on the input and can instruct offloading component 102 to connect to a determined network based on the wireless offloading schema. It is noted that the terms offloading scheme, connection schema, offloading preferences, connection preferences and the like are used interchangeably herein, unless context suggests otherwise.

In an aspect, selection component 120 can select a determined network based on a type of service associated with a transmission. A service can refer to an available activity, content delivery, internet protocol multimedia subsystem service, communication service, connection to a network, and the like. Services can include voice calls (over legacy voice network), internet based data services (e.g., internet browsing), over the top data applications, video over internet protocol, voice over internet protocol, email, internet protocol multimedia core network subsystem based video calling, internet protocol multimedia core network subsystem based messaging, internet protocol multimedia core network subsystem based voice calling, simple messaging service, rich communication messaging service and the like. As an example, selection component 120 can determine to connect to a wireless fidelity (WiFi) network for transmissions associated with video call services (e.g., video calls internet protocol) and can determine to connect to a cellular network for voice call services.

Selection component 120, in response to connecting to a determined network, can transmit and receive data based on a selected network (e.g., radio access network, wireless fidelity network, etc.). As an example, selection component 120 can determine to transmit packet data, a data stream, error correction protocols, and the like based on a type associated with a selected network.

In another aspect, selection component 120 can receive input indicating a preference associated with offloading transmissions from a first network to a second network. For example, a user can provide input 110 based on a user's subjective preference. Input 110 can include data indicating a preference to utilize a determined network for transmissions associated with a selected type of service(s). It is noted that the determined network can comprise a default network, a cellular network, an internet protocol based network, and the like. A default network can comprise a cellular network, an internet protocol based network, or the like, depending on a type of user equipment device. It is further noted that preferences associated with offloading transmissions can be stored, for example, in storage 108, and that a stored preference can be based on network connections.

Selection component 120 can determine an offloading schema based on received input identifying a specific network and/or characteristics of a network. Selection component 120 can associate the specific network or characteristics of a network with an offloading schema. For example, a user can select a network and select associated preferences via an interface. In another aspect, select characteristics of a network (e.g., type, security level, transmission speed, etc.) and can be associated with an offloading schema. It is noted that selection component 120 can apply an offloading schema to decrease cost associated with transmissions, alter speed of transmissions, and alter bandwidth utilization and the like. For example, selection component 120 can determine, based on user input, an offloading schema that utilizes free or less expensive networks for transmissions or that is based at least in part on a bandwidth utilization associated with a billing cycle. In another example, selection component 120 can determine an offloading schema to maximize bandwidth utilization (e.g., select networks based on network speed).

In implementations, selection component 120 can determine an offloading preference based on a history associated with iterations of selecting offloading preferences. In an aspect, selection component 120 can analyze a history of offloading and determine identifiable correlations between networks, offloading preferences, times, dates, locations, and the like. For example, selection component 120 can determine that a correlation between a wireless fidelity network's security level and offloading preference exists. Selection component 120 can apply the determined correlation to other wireless fidelity networks having a parameter meeting a defined criterion (e.g, similar security level).

In another aspect, selection component 120 can utilize offloading schemas stored in storage 108. Storage 108 can comprise a set of schemas that can be utilized to manage wireless offloading. It is noted that the schemas can be ranked in an order of preference such that a higher ranked schema is utilized when possible. For example, if connected to a first network, selection component 120 can select the highest ranked schema compatible with the first network.

Selection component 120 can communicate stored offloading schemas with user equipment devices. User equipment devices can apply the offloading schemas to manage their respective transmissions. For example, selection component 120 can determine a default offloading schema for a particular network (e.g., coffee shop network). The default offloading schema can be communicated to user equipment devices within a range of the network and the user equipment devices can employ the default offloading schema. It is noted that a user equipment device can override a default offloading schema.

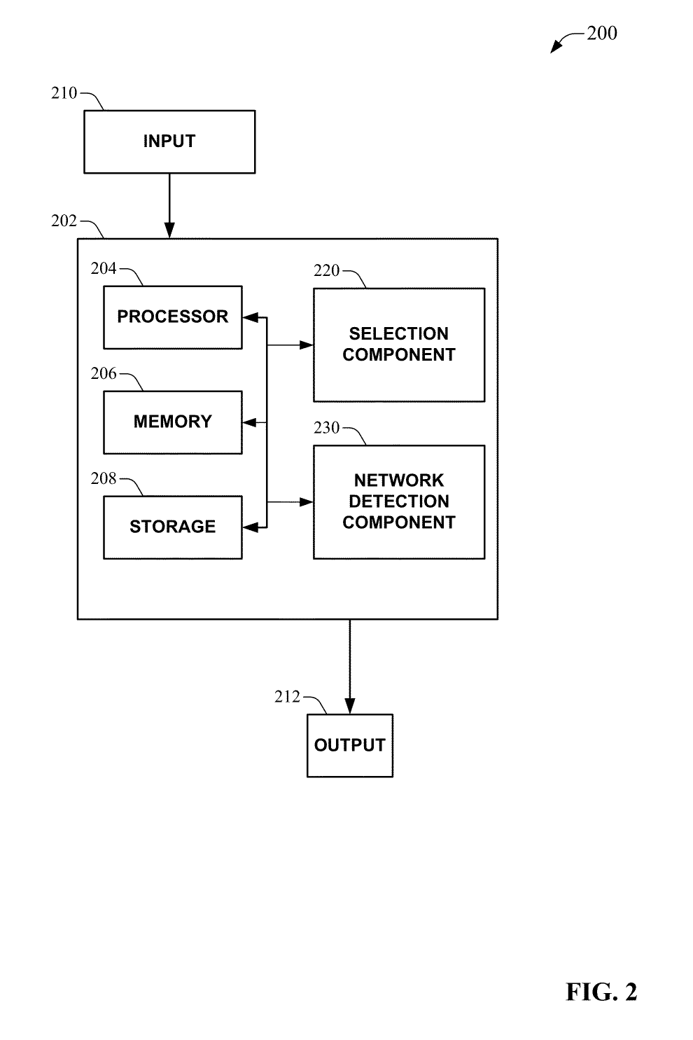

FIG. 2 illustrates a system 200 for managing network selections, where user equipment devices access, communicate, and/or conduct data interchange using disparate access network technology types. System 200 can include offloading component 202 that comprises selection component 220 and network detection component 230 that can be coupled to processor 204, memory 206, and storage 208. As illustrated, selection component 220 and network detection component 230 can be in communication with processor 204 for facilitating operation of computer executable instructions and components, memory 206 for storing data and the computer executable instructions and components such as selection component 220 (which can facilitate selection of a network based on a preference) and network detection component 230 (which can determine characteristics and availability of networks), and storage 208 for providing longer-term storage of data and/or computer executable components and instructions. Additionally, system 200 can also receive input 210 for use, manipulation, and/or transformation by selection component 220 and network detection component 230 to produce one or more useful, concrete, and tangible result. Further, system 200 can also generate and output the useful, concrete, and tangible result produced by selection component 220 as output 212.

Network detection component 230 can determine characteristics associated with a network. A characteristic can comprise an availability status, a signal strength, power consumption, bandwidth utilization, security level, a history of use associated with a network, network type, and the like. For example, network detection component 230 can receive, as input 210, data describing a network from an access point. In response to receiving the data, network detection component 230 can analyze the data and determine characteristics associated with the network. It is noted that network detection component 230 can store data describing characteristics associated with a network in storage 208. It is further noted that network detection component 230 can receive input from storage 208.

In another aspect, selection component 220 can receive data, from network detection component 230, associated with characteristics of a network. Selection component 220 can render an interface presentation to present the network characteristics. For example, selection component 220 can render a list of available networks, associated signal strengths, and the like.

In response to network detection component 230 detecting a characteristic of a network, selection component 220 can apply a stored offloading preference to alter a connection and transmissions associated with services. Altering a connection and transmissions can comprise switching connection from a first network to a second network, transmitting data over a disparate network, and the like.

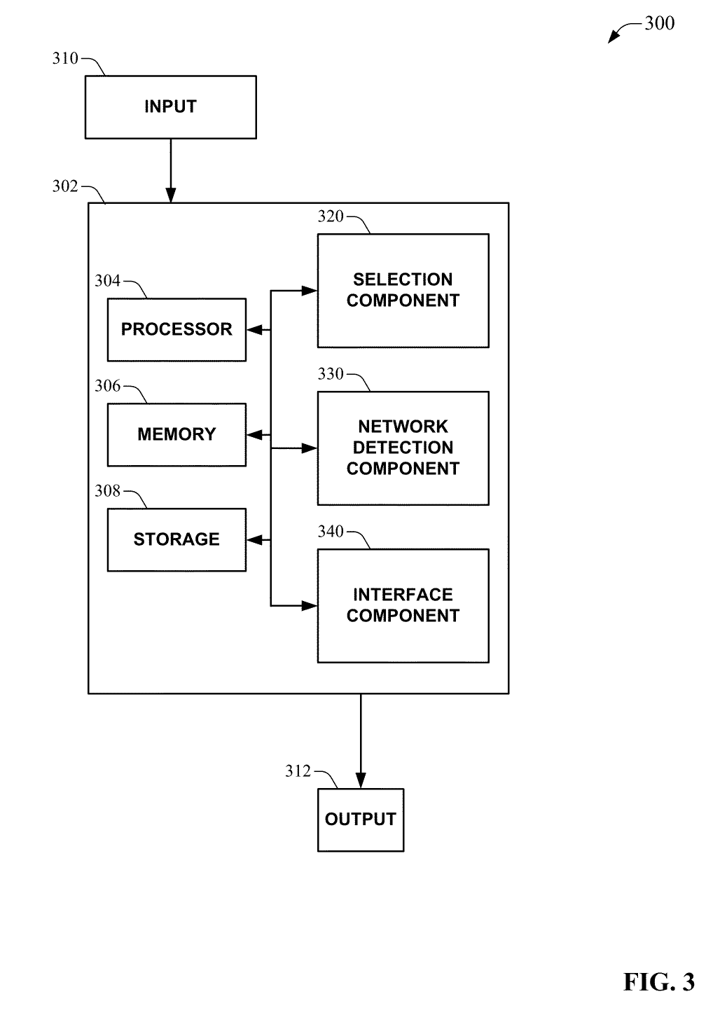

FIG. 3 illustrates a system 300 for managing network selections, where user equipment devices access, communicate, and/or conduct data interchange using disparate access network technology types. System 300 can include offloading component 302 that comprises selection component 320, network detection component 330, and interface component 340 that can be coupled to processor 304, memory 306, and storage 308. As illustrated, the various components can be in communication with each other. It is noted that various components can comprise functionality described with reference to FIG. 1 and FIG. 2.

Interface component 340 can render, as output 312, a presentation screen. The presentation screen can comprise data received from selection component 320 and network detection component 330. In an aspect, interface component 340 can render lists of available networks, offloading options, and the like. In another aspect, interface component 340 can receive input 310 representing a selection of a network, offloading options, and the like.

In an aspect, interface component 340 can render confirmation screens to confirm a selected option was correctly accepted, prompt a user to select storage criteria, alert a user that an offloading scheme is being utilized, and the like.

Interface component 340 can, in response to network detection component 330 detecting a newly available network, render a notification screen, generate an audible chime, activate a light such as a light emitting diode, and the like. It is noted that interface component 340 can generate the notification based on occurrence of various events such as a network characteristic meeting a defined threshold. In another aspect, interface component 340 can prompt a user to input a selection associated with wireless offloading. For example, in response to detecting a network that has not been previously connected to by system 300, interface component 340 can prompt a user to enter desired offloading options or select a stored offloading schema.

It is noted that selection component 320 can utilize various default settings and can provide override capabilities to negate a notification from interface component 340. In another aspect selection component 320 can communicate stored preferences to interface component 320 and interface component 320 can store the preferences.

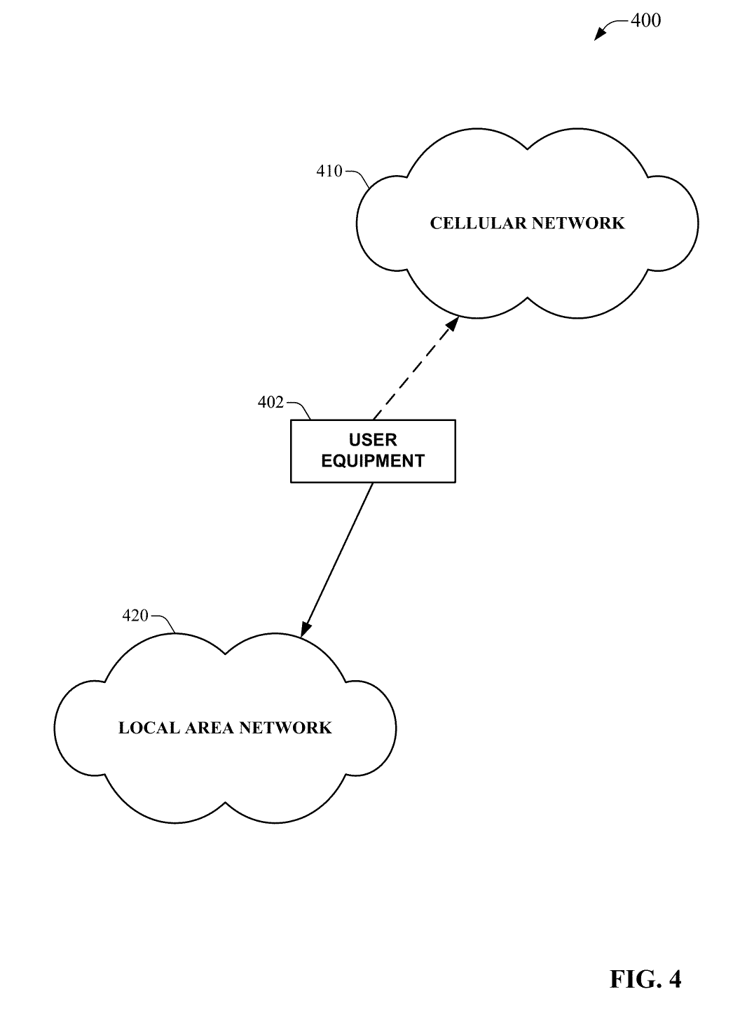

FIG. 4 illustrates a system 400 for managing network selections, where user equipment devices access, communicate, and/or conduct data interchange using disparate access network technology types. System 400 can include user equipment device 402 that comprises one or more aspects of an offloading component as described with reference to FIGS. 1-3. As illustrated user equipment device 402 can be in communication with cellular network 410 and local area network 420.

It is noted that user equipment device 402 can be in communication with additional networks, in communication with networks of various types including wireless and wire-lined networks, or not in communication with any network.

User equipment device 402 can initiate a rendering of a wireless offloading selection display for configuring wireless offloading of a transmission from a first network devices of a first radio access network (e.g., cellular network 410) and second network devices of a second radio access network (e.g., local area network 420). In another aspect, user equipment device 402 can, in response to input received via the wireless offloading selection display, determine a wireless offloading schema to apply to the transmission.

As an example, user equipment device 402 can implement offloading preferences to perform voice calls (solid line) through local area network 420 while performing transmissions associated with an over the top application (dotted line) with cellular network 410. It is noted that user equipment device 402 can communicate with each network simultaneously, substantially simultaneously, or at disparate times. It is noted that the above is an example of providing services through selection of various networks and offloading preferences can be implemented based on various other settings. For example, a voice call can be services by cellular network 410 and over the top communications can be services through local area network 420.

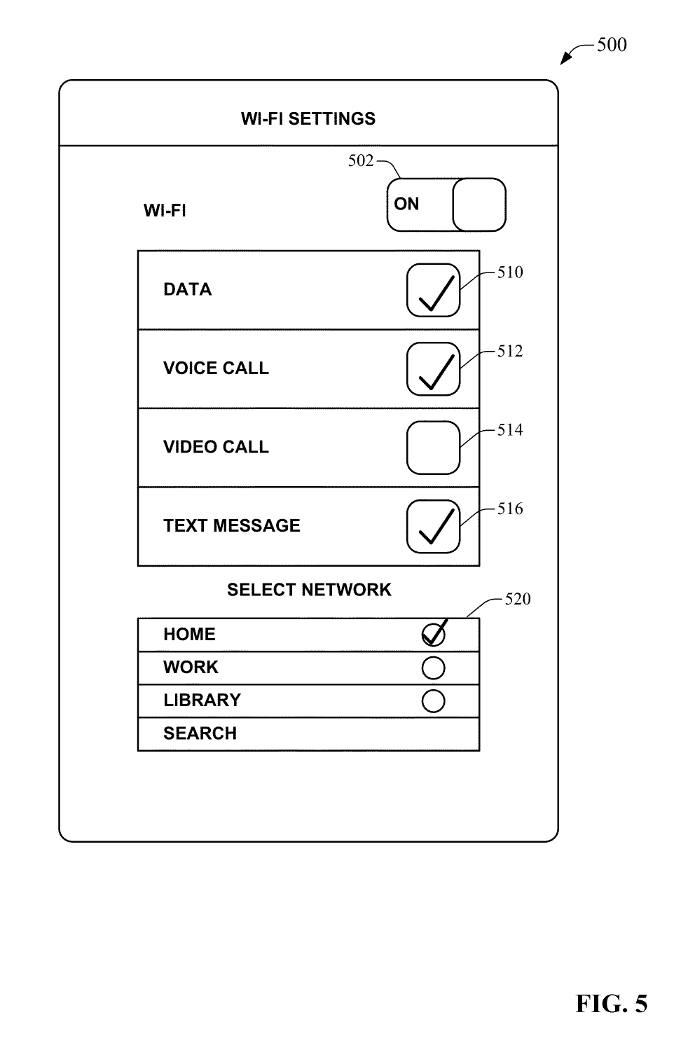

FIG. 5 is a depiction of an illustrative offloading selection display 500 as displayed on a user equipment device, such as user equipment device 402 (with reference to FIG. 4) utilizing offloading components 102, 202 and 302 (with reference to FIG. 13), in accordance with the subject disclosure. As depicted, offloading selection display 500 can include wireless fidelity control 502, data offloading control 510, voice call offloading control 512, video call offloading control 514, text message offloading control 516, and network selection control 520. The selectivity of association of offloading controls with network selection control 520 can be based on, or be a function of, a received (or previously received) offloading preference, as detailed above. It is noted that various other offloading options can be rendered, such as by interface component 340, on offloading selection display 500. It is further noted that, offloading selection display 500 can be rendered in various formats, comprise multiple screens, and the like.

In an aspect, data offloading control 510, voice call offloading control 512, video call offloading control 514, and text message offloading control 516 can control transmissions associated with respective services based on a preference and a network selection. For example, a home network can be selected from network selection control 520. Selection of the home network can cause data offloading control 510, voice call offloading control 512, video call offloading control 514, text message offloading control 516 and wireless fidelity control 502 based on a stored preference, a default preference, a history of connections, and the like.

In another aspect, wireless fidelity control 502 can be in an on state or an off state. In an off state, wireless fidelity control 502 can turn off or disable all services utilizing wireless fidelity networks. It is noted that controls for the services can be disabled, hidden, or otherwise altered. When control wireless fidelity control 502 is in an “on” state, an access preference (e.g., stored preference, default preference, etc.) can be applied for a selected network and/or network to be connected to.

In another aspect, offloading preferences can be stored for a selected network, for similar networks, or for all networks. For example, a user can select a home network from network selection control 520 and can select desired service offloading controls. In response, system 500 can store the selected preferences and can apply the preferences when system 500 detects that the home network is available. In another aspect, system 500 can prompt a user to select whether the user desires to apply the preferences to all networks, similar networks, no networks, just a selected network(s), and the like.

It is noted that controlling transmissions, controlling connections, and the like can represent managing connections to networks and transmissions to networks. As an example, with reference to FIG. 4, system 500 can manage transmissions between user equipment device 402, local area network 420, and cellular network 410.

It is noted that a user equipment or a device can override any of the settings. For example, a user equipment can universally apply an offloading scheme to all services associated with the user equipment. However, a user can provide input regarding a desired to opt out or override the offloading schema for a particular application or group of application, during a particular time, at a particular geographic position, when a metric of a network meets a defined criterion (e.g., WiFi signal meets a signal strength threshold, data usage meets a threshold based on an end user agreement, etc.) and the like.

Data offloading control 510 can control transmissions associated with over the top applications and applications not falling in other categories of services. These “data applications” can comprise content delivery services such as content deliver applications, multimedia messaging service, internet browsers, media players, gaming applications, and the like. In response to selecting data offloading control 510, a selection component (e.g., selection component 120 of FIG. 1) can determine to utilize a selected network, in network selection control 520, for transmissions associated with defined services represented by the data control 510.

Voice call offloading control 512 can control transmissions associated with voice services. Voice services can comprise voice calls utilizing a cellular network, voice calls utilizing an internet protocol network, and the like. In response to selecting voice offloading control 512, a selection component (e.g., selection component 120 of FIG. 1) can determine to utilize a selected network, in network selection control 512, for transmissions associated with defined services represented by voice offloading control 510. In an aspect, a selection component can determine appropriate transmissions based on the selectivity status of voice call control component 512. In another aspect, in response to voice offloading control 512 being in a state defined as an unselected state, a selection component can determine to transmit data associated with voice services over a cellular network or a default network.

Video call offloading control 514 can control transmissions associated with video calling services. Video calling services can comprise video calls (video chats) utilizing a cellular network, voice calls utilizing an internet protocol network, and the like. In response video call offloading control 514, being in a state defining a selected state a selection component (e.g., selection component 120 of FIG. 1) can determine to utilize a selected network, in network selection control 520, for transmissions associated with defined services represented by video call offloading control 514. In an aspect, a selection component can determine appropriate transmissions based on the selectivity status of video call control component 514. In another aspect, in response to video call offloading control 514 being in a state defined as an unselected state, a selection component can determine to transmit data associated with video calling services over a cellular network or a default network.

Text message offloading control 516 can control transmissions associated with text messaging services. Text messaging services can comprise short message services or emerging Rich Communication Multimedia messaging service utilizing a cellular network or an internet protocol network and the like. In response text messaging offloading control 516, being in a state defining a selected state a selection component (e.g., selection component 120 of FIG. 1) can determine to utilize a selected network, in network selection control 520, for transmissions associated with defined services represented by text messaging offloading control 516. In an aspect, a selection component can determine appropriate transmissions based on the selectivity status of text messaging offloading control 516. In another aspect, in response to text messaging offloading control 516 being in a state defined as an unselected state, a selection component can determine to transmit data associated with text messaging services over a cellular network or a default network.

Network selection control 520 can control what network offloading controls apply to a particular network. As an example, a specific network can be in a stated defined as selected or a stated defined as unselected. In response to a network being in a selected state, a selection component (e.g., selection component 120 of FIG. 1) can apply offloading controls to transmissions associated with various services associated with an offloading control in a selected state via the selected network. In response to a network being in an unselected state, system 500 will not transmit utilizing the network or will not apply the settings to the unselected network(s).

In another aspect, network selection control 520 can render networks based on data received from a network detection component (e.g., network detection component 330). For example, a network detection component can determine characteristics of a network (availability, signal strength, security level, user preference, etc.). Network selection control 520 can render the characteristics, a list of available networks, sort networks based on the characteristics, and the like.

A selection component (e.g., selection component 120 of FIG. 1) can control transmissions associated with a user equipment device (e.g., user equipment device 402) based on offloading controls, network selection control 420, and network characteristics. It is noted that an interface component (interface component 340) can render controls (via system 500) to enable selection of desired criterion for offloading controls. As an example, system 500 can have options to allow only transmissions associated with certain services over a determined network or type of network, apply a select offloading preference when a determined network is available while applying a disparate offloading preference when a second network is available, and the like.

With reference to FIGS. 1-4, offloading selection display 500 can receive data as input (e.g., input 110, 210, and 310) indicating an offloading connectivity preference. In an aspect, data offloading control 510, voice call offloading control 512, video call offloading control 514, text message offloading control 516, and network selection control 520 can comprise a selectable toggle control, check box control and the like to turn alter states of offloading controls and networks associated with the controls.

It is noted that, various services for offloading can be selectable depending on or as a function of the capabilities of a user equipment device, service agreements, and the like. For example, a user equipment device may not have video call capabilities and, in response, a selection component (e.g., selection component 120) can disable video call offloading control 512. In another aspect, an interface component (e.g., interface component 340) can render determined offloading controls based on available services, service agreements and the like. For example, interface component 340 can render offloading selection display 500 with controls for associated services based on a user service agreement.

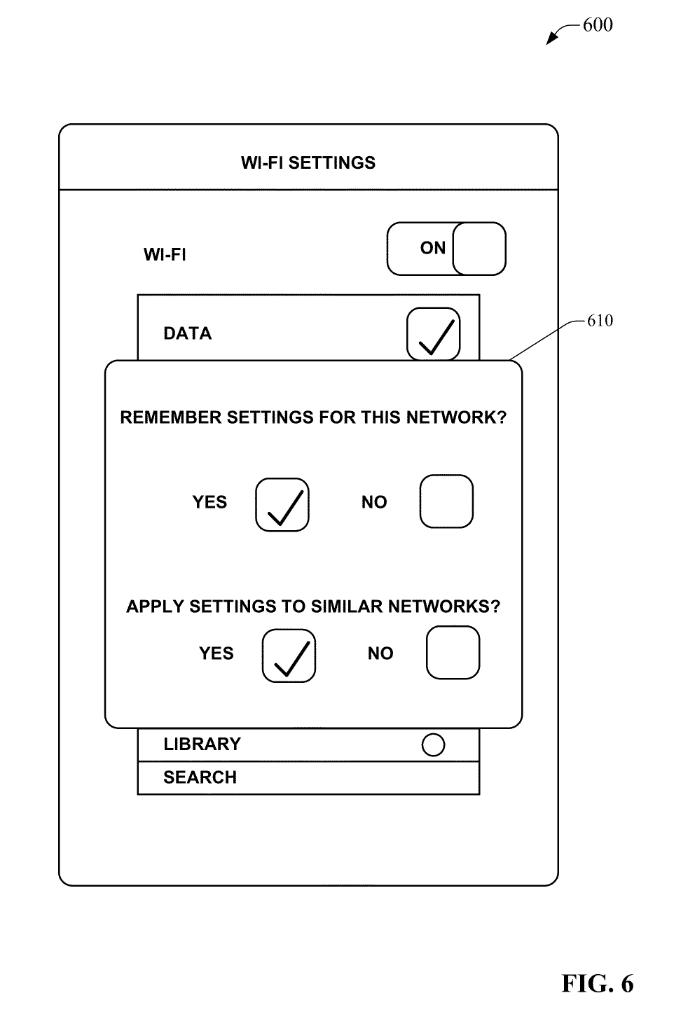

FIG. 6 is a depiction of a system 600 that renders a notification screen 610 as rendered by a user equipment device, such as user equipment device 402, in accordance with the subject disclosure. As depicted, notification screen 610 can prompt a user to provide input associated with saving network offloading preferences. For example, with reference to FIG. 5, a user can provide input associated with network and offloading preferences. In response to receiving input, a user equipment device (e.g., user equipment device 402 of FIG. 4) can render notification screen 610.

Notification screen 610 can provide controls associated with saving offloading preferences, applying offloading preferences to other networks, and the like. In an aspect, notification screen 610 can provide controls to receive input associated with various aspects. Accordingly, while notification screen 610 is illustrated as prompting a user to select whether settings are remembered for a network and applied to a similar network, it is noted that notification screen 610 can prompt a user to select whether settings should be applied for all networks, should only be applied to networks meetings a defined criterion, and the like.

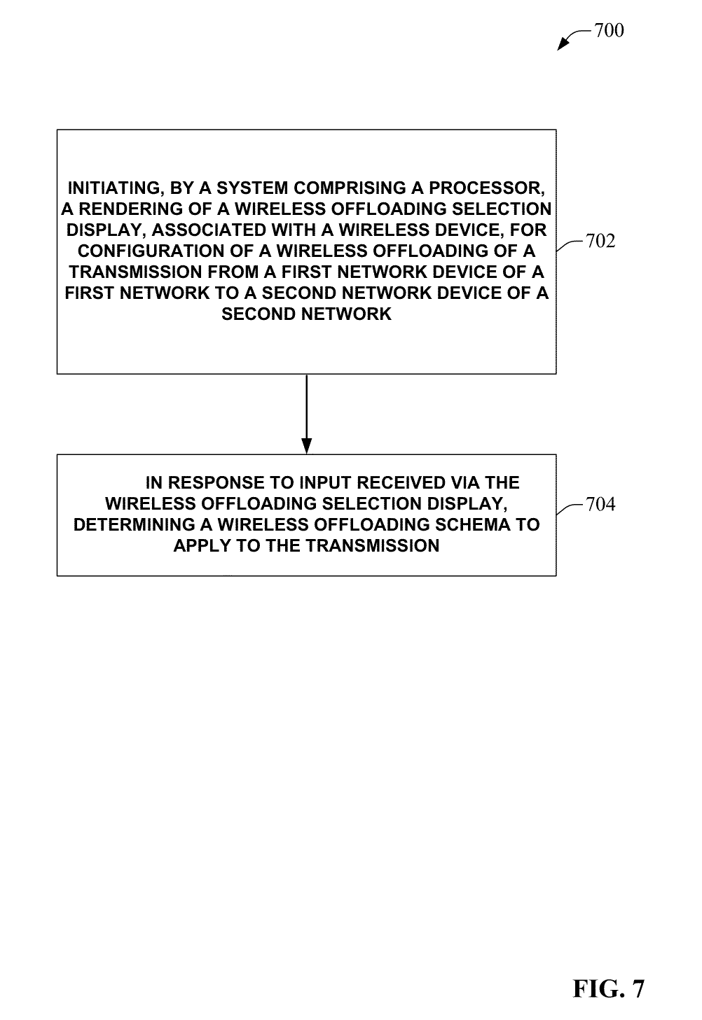

In view of the example system(s) described above, example method(s) that can be implemented in accordance with the disclosed subject matter can be better appreciated with reference to flowcharts in FIGS. 7-9. The methods in FIGS. 7-9 can be implemented for example by systems 100, 200, 300, 400, 500, and 600 illustrated in FIGS. 1-6 respectively. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 7 illustrates a method 700 for enhancing user experience for Internet Protocol Multimedia Core Network Subsystem based rich communication services in multiple access wireless communication networks/infrastructures. In an aspect, method 700 can provide fine grained control of wireless offloading of services.

At 702, a system can initiate a rendering (e.g., via interface component 340) of a wireless offloading selection display, associated with a wireless device, for configuring wireless offloading of a transmission from a first network device of a first network to a second network devices of a second network. For example, user equipment device 402 can initiate a rendering of system 500.

At 704, a system can, in response to input received via the wireless offloading selection display, determine a wireless offloading schema to apply to the transmission. A wireless offloading schema can comprise preferences representing a user's selection of wireless offloading for select services and a network to wirelessly offload the services to. For example, the wireless offloading schema can comprise data describing whether a set of services should use a first network for transmissions and whether a second set of services should use a second network for transmissions.

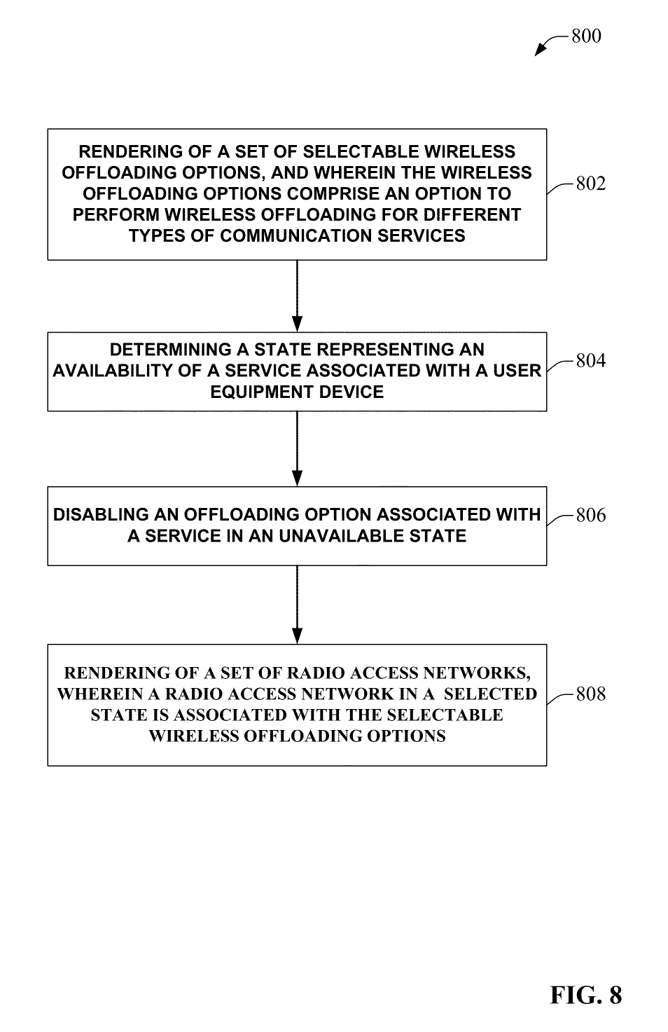

FIG. 8 illustrates a method 800 for enhancing user experience for Internet Protocol Multimedia Core Network Subsystem based rich communication services in multiple access wireless communication networks/infrastructures including rending wireless offloading options.

At 802, a system can initiate (e.g., via interface component 340) a rendering of a set of selectable wireless offloading options, and wherein the wireless offloading options comprise an option to perform wireless offloading for different types of communication services.

At 804, a system can determine a state of a service, wherein the state represents an availability of a service associated with a user equipment device. For example, a system can determine if a user equipment comprise hardware needed for video chatting, a service plan supports text messaging, and the like.

At 806, a system can disable an offloading option associated with a service in an unavailable state. Disabling the offloading option can comprise rendering the offloading option as un-selectable, removing the offloading option, and the like.

At 808, a system can render of a set of radio access networks, wherein a radio access network in a selected state is associated with the selectable wireless offloading options.

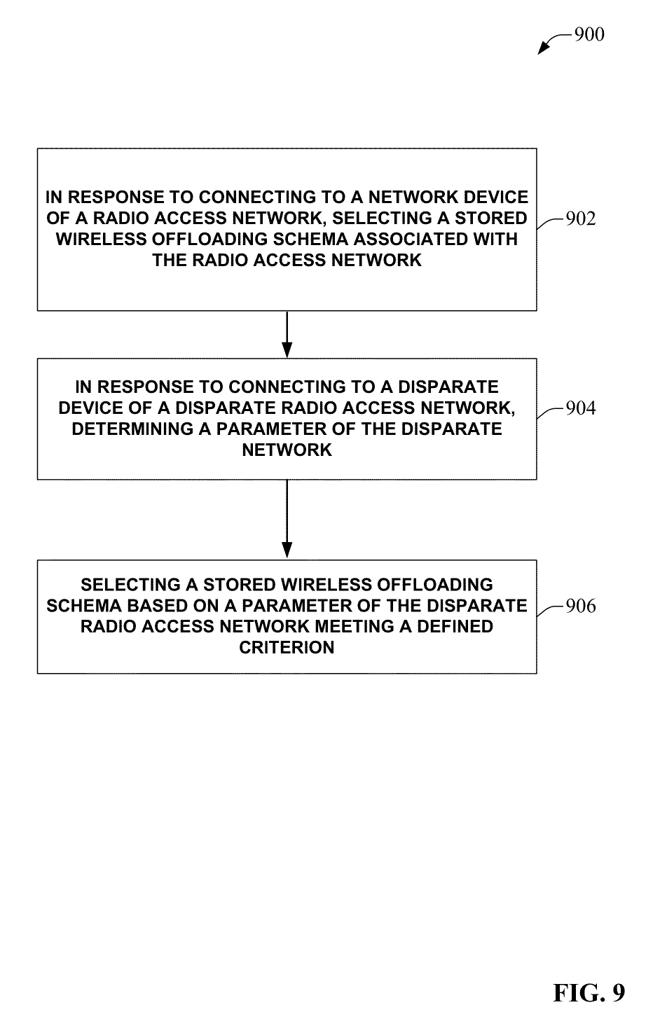

FIG. 9 illustrates a further method 900 for fine-grained control for wireless offloading of services associated with a user equipment device. At 902, in response to connecting to a network device of a radio access network, a system can select a stored wireless offloading schema associated with the radio access network.

At 904, in response to connecting to a disparate device of a disparate radio access network, a system can determine (e.g., via network detection component 230) a parameter of the disparate network. A parameter can comprise an availability status, a signal strength, power consumption, bandwidth utilization, security level, a history of use associated with a network, network type, and the like.

At 906, a system can select a stored wireless offloading schema based on a parameter of the disparate radio access network meeting a defined criterion. For example, a system can select an offloading schema based on a network becoming available, a speed of a network meeting a threshold, etc.

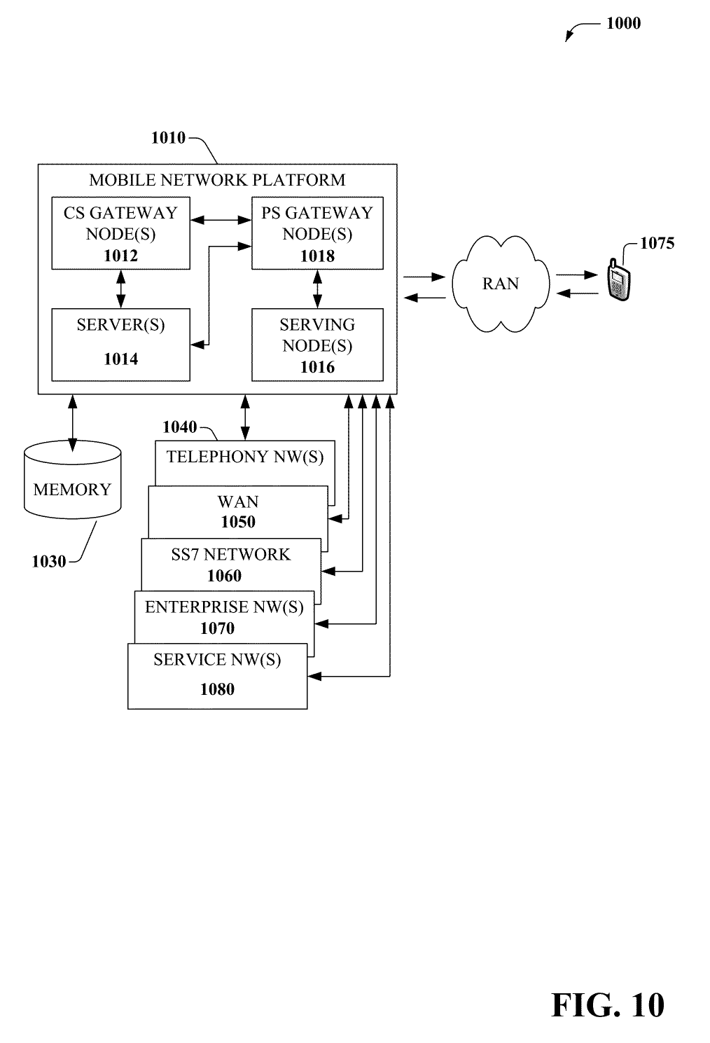

FIG. 10 presents an example embodiment 1000 of a mobile network platform 1010 that can implement and exploit one or more aspects of the disclosed subject matter described herein. Generally, wireless network platform 1010 can include components, e.g., nodes, gateways, interfaces, servers, or disparate platforms, that facilitate both packet-switched (PS) (e.g., internet protocol (IP), frame relay, asynchronous transfer mode (ATM)), circuit-switched (CS) traffic (e.g., voice and data), and Service Network (e.g. IMS) as well as control generation for networked wireless telecommunication. As a non-limiting example, wireless network platform 1010 can be included in telecommunications carrier networks, and can be considered carrier-side components as discussed elsewhere herein. Mobile network platform 1010 includes CS gateway node(s) 1012 which can interface CS traffic received from legacy networks like telephony network(s) 1040 (e.g., public switched telephone network (PSTN), or public land mobile network (PLMN)) or a signaling system #7 (SS7) network 1070. Circuit switched gateway node(s) 1012 can authorize and authenticate traffic (e.g., voice) arising from such networks. Additionally, CS gateway node(s) 1012 can access mobility, or roaming, data generated through SS7 network 1070; for instance, mobility data stored in a visited location register (VLR), which can reside in memory 1030. Moreover, CS gateway node(s) 1012 interfaces CS-based traffic and signaling and PS gateway node(s) 1018. As an example, in a 3GPP UMTS network, CS gateway node(s) 1012 can be realized at least in part in gateway GPRS support node(s) (GGSN). It should be appreciated that functionality and specific operation of CS gateway node(s) 1012, PS gateway node(s) 1018, and serving node(s) 1016, is provided and dictated by radio technology(ies) utilized by mobile network platform 1010 for telecommunication.

In addition to receiving and processing CS-switched traffic and signaling, PS gateway node(s) 1018 can authorize and authenticate PS-based data sessions with served mobile devices. Data sessions can include traffic, or content(s), exchanged with networks external to the wireless network platform 1010, like wide area network(s) (WANs) 1050, enterprise network(s) 1070, and service network(s) 1080 such as an internet Multimedia Core Network Subsystem (IMS), local area network(s) (LANs), which can be interfaced with mobile network platform 1010 through PS gateway node(s) 1018. It is to be noted that WANs 1050 (may be via Internet) and enterprise network(s) 1060 (may be via Virtual Private Network) can embody, at least in part, a service network(s) like IP multimedia subsystem (IMS). Based on radio technology layer(s) available in technology resource(s) 1017, packet-switched gateway node(s) 1018 can generate packet data protocol contexts when a data session is established; other data structures that facilitate routing of packetized data also can be generated. To that end, in an aspect, PS gateway node(s) 1018 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1000, wireless network platform 1010 also includes serving node(s) 1016 that, based upon available radio technology layer(s) within technology resource(s) 1017, convey the various packetized flows of data streams received through PS gateway node(s) 1018. It is to be noted that for technology resource(s) 1017 that rely primarily on CS communication, server node(s) can deliver traffic without reliance on PS gateway node(s) 1018; for example, server node(s) can embody at least in part a mobile switching center. As an example, in a 3GPP UMTS network, serving node(s) 1016 can be embodied in serving GPRS support node(s) (SGSN).

For radio technologies that exploit packetized communication, server(s) 1014 in wireless network platform 1010 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1010. Data streams (e.g., content(s) that are part of a voice call or data session) can be conveyed to PS gateway node(s) 1018 for authorization/authentication and initiation of a data session, and to serving node(s) 1016 for communication thereafter. In addition to application server, server(s) 1014 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1010 to ensure network's operation and data integrity in addition to authorization and authentication procedures that CS gateway node(s) 1012 and PS gateway node(s) 1018 can enact. Moreover, provisioning server(s) can provision services from external network(s) like networks operated by a disparate service provider; for instance, WAN 1050 or Global Positioning System (GPS) network(s) (not shown). Provisioning server(s) can also provision coverage through networks associated to wireless network platform 1010 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 1075.

It is to be noted that server(s) 1014 can include one or more processors configured to confer at least in part the functionality of macro network platform 1010. To that end, the one or more processor can execute code instructions stored in memory 1030, for example. It is should be appreciated that server(s) 1014 can include a content manager 1015, which operates in substantially the same manner as described hereinbefore.

In example embodiment 1000, memory 1030 can store information related to operation of wireless network platform 1010. Other operational information can include provisioning information of mobile devices served through wireless platform network 1010, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1030 can also store information from at least one of telephony network(s) 1040, WAN 1050, enterprise network(s) 1060, or SS7 network 1070. In an aspect, memory 1030 can be, for example, accessed as part of a data store component or as a remotely connected memory store.

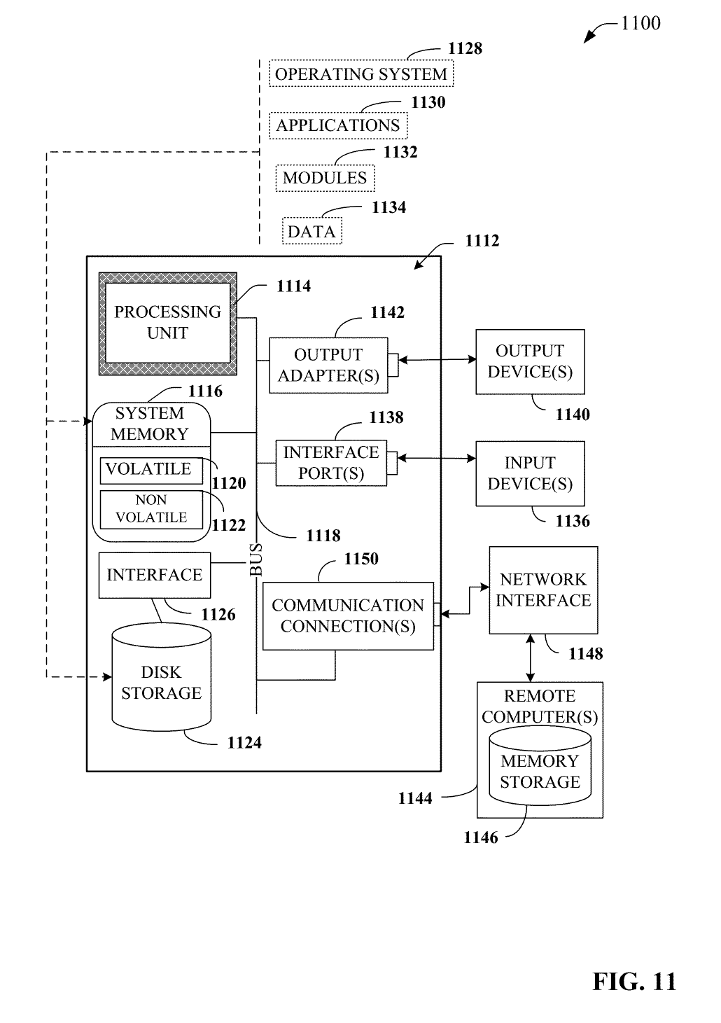

In order to provide a context for the various aspects of the disclosed subject matter, FIG. 11, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1120 (see below), non-volatile memory 1122 (see below), disk storage 1124 (see below), and memory storage 1146 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 11 illustrates a block diagram of a computing system 1100 operable to execute the disclosed systems and methods in accordance with an embodiment. Computer 1112, which can be, for example, part of the hardware of an operating support system 102 or user equipment, includes a processing unit 1114, a system memory 1116, and a system bus 1118. System bus 1118 couples system components including, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1116 can include volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can include ROM, PROM, EPROM, EEPROM, or flash memory. Volatile memory 1120 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 can also include removable/non-removable, volatile/nonvolatile computer storage media. FIG. 11 illustrates, for example, disk storage 1124. Disk storage 1124 includes, but is not limited to, devices like a magnetic disk drive, floppy disk drive, tape drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CDROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 11 describes software that acts as an intermediary between users and computer resources described in suitable operating environment 1100. Such software includes an operating system 1128. Operating system 1128, which can be stored on disk storage 1124, acts to control and allocate resources of computer system 1112. System applications 1130 take advantage of the management of resources by operating system 1128 through program modules 1132 and program data 1134 stored either in system memory 1116 or on disk storage 1124. It is to be noted that the disclosed subject matter can be implemented with various operating systems or combinations of operating systems.

A user can enter commands or information into computer 1112 through input device(s) 1136. As an example, operations support system 102 can include a user interface embodied in a touch sensitive display panel allowing a user to interact with computer 1112. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1114 through system bus 1118 by way of interface port(s) 1138. Interface port(s) 1138 include, for example, a serial port, a parallel port, a game port, a universal serial bus (USB), an infrared port, a Bluetooth port, an IP port, or a logical port associated with a wireless service, etc. Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140 like monitors, speakers, and printers, among other output devices 1140, which use special adapters. Output adapters 1142 include, by way of illustration and not limitation, video and sound cards that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, cloud storage, cloud service, a workstation, a microprocessor based appliance, a peer device, or other common network node and the like, and typically includes many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically connected by way of communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A system, comprising:
a memory that stores executable instructions; and
a processor, coupled to the memory, that facilitates execution of the executable instructions to perform operations, comprising:
initiating a rendering of a wireless offloading selection display, associated with a wireless device, enabling configuration of a wireless offloading of a transmission from a first network device of a first radio access network to a second network device of a second radio access network; and
in response to input received via the wireless offloading selection display, determining a wireless offloading schema to apply to the transmission, wherein the wireless offloading schema comprises a first preferred offloading for the wireless device for a first type of communication with the wireless device and a second preferred offloading for the wireless device for a second type of communication with the wireless device.

2. The system of claim 1, wherein the operations further comprise:
based on the wireless offloading schema, selecting a network device, from a group of network devices comprising the first network device and the second network device, for the transmission.

3. The system of claim 1, wherein the rendering comprises a set of selectable wireless access network offloading options, and wherein the set of selectable wireless offloading options comprises an option to perform wireless offloading for different types of communication services.

4. The system of claim 3, wherein the rendering comprises a set of selectable radio access networks, and wherein the set of selectable wireless offloading options are applied to a radio access network of the set of selectable radio access networks determined to be in a defined state.

5. The system of claim 1, wherein the rendering comprises a set of selectable wireless offloading options, and wherein the set of selectable wireless offloading options comprises an option to perform wireless offloading for a voice calling service.

6. The system of claim 1, wherein the rendering comprises a set of selectable wireless offloading options based on services determined to be available to the wireless device.

7. The system of claim 1, wherein the operations further comprise:
in response to connecting to the second network device of the second radio access network, selecting the wireless offloading schema associated with the second radio access network and receiving schema data comprising the wireless offloading schema from a storage device.

8. The system of claim 1, wherein the operations further comprise:
in response to connecting to a third network device of a third radio access network, requesting the wireless offloading schema from a storage device based on a parameter of the third radio access network being determined to satisfy a defined criterion.

9. The method of claim 8, wherein the defined criterion is a criterion selected from a radio access network security metric.

10. A method, comprising:
initiating, by a system comprising a processor, a rendering of a wireless offloading selection display, associated with a wireless device, for configuration of a wireless offloading of a transmission from a first network device of a first network to a second network device of a second network; and
in response to input received via the wireless offloading selection display and in response to a condition of an end user agreement for an end user associated with the wireless device being determined to be satisfied, determining, by the system, a wireless offloading schema to apply to the transmission.

11. The method of claim 10, wherein the rendering of the wireless offloading selection display comprises a display of a set of controls for services associated with the wireless device.

12. The method of claim 11, further comprising:
in response to determining a control, associated with a determined service, of the set of controls is in a selected state, altering, by the system, a transmission parameter of another transmission associated with the determined service.

13. The method of claim 11, wherein the set of controls manage the wireless offloading schema for a text messaging service.

14. The method of claim 10, wherein the determining the wireless offloading schema to apply further comprises:
determining the wireless offloading schema based on a determined status of the second radio access network.

15. The method of claim 10, further comprising:
in response to receiving the input, determining, by the system, the wireless offloading schema is further based on a power metric.

16. The method of claim 10, further comprising:
in response to applying the wireless offloading schema, generating, by the system, a notification to signify that the wireless offloading schema has been applied.

17. A non-transitory computer readable medium comprising instructions that, in response to execution, cause a system comprising a processor to perform operations, comprising:
facilitating a display of a wireless offloading selection display, associated with a first wireless device, for configuration of a wireless offloading of a transmission from a first network device of a first radio access network to a second network device of a second radio access network; and
in response to input received via the wireless offloading selection display, determining a wireless offloading schema to apply to the transmission, wherein the wireless offloading schema comprises a first type of network for offloading communication of the wireless device for a first type of communication with the wireless device and a second type of network for offloading communication of the wireless device for a second type of communication with the wireless device.

18. The non-transitory computer readable medium claim 17, wherein the facilitating the display of the wireless offloading selection display further comprises:
determining a service is in a state defined as unavailable; and
facilitating the display of a representation of the service associated with an un-selectable state.

19. The non-transitory computer readable medium of claim 17, wherein the facilitating the display of the wireless offloading selection display further comprises:
facilitating the display of network characteristics to be associated with the wireless offloading schema.

20. The non-transitory computer readable medium of claim 17, wherein the operations further comprise:
sending the wireless offloading schema to a second wireless device.
